(19) United States
(12) Patent Application Publication
(10) Pub. No.: US 2006/0206526 A1
(43) Pub. Date: Sep. 14, 2006

(54) Video editing method and apparatus

(75) Inventor: Leonard Sitomer, Wellesley, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: PortalVideo, Inc., Wellesley, MA (US)

(21) Appl. No.: 11/371,251

(22) Filed: Mar. 8, 2006

Related U.S. Application Data
(60) Provisional application No. 60/660,218, filed on Mar. 10, 2005.

(51) Int. Cl. G06F 17/00

(52) U.S. Cl. 707/104.1

(57) ABSTRACT

A computer video editing system and method in a network of computers is disclosed. The system and method include a datastore or other source of subject video data, a transcription module and an assembly member. The transcription module generates a working transcript of the corresponding audio data of subject source video data. The working transcript includes original source video time coding for the passages (statements) forming the transcript. The assembly member enables user selection and ordering of transcript portions. For each user selected transcript portion, the assembly member, in real-time, (i) obtains the respective corresponding source video data portion and (ii) combines the obtained video data portions to form a resulting video work. The resulting video work is displayed to users and may be displayed simultaneously with display of the whole original working transcript to enable further editing and/or user comment. A text script of the resulting video work is also displayed. The video editing system and method may be implemented in a local area network of computers, as a browser based application on a host in a global computer network, as well as on stand alone computer configurations with a remote or integrated transcription service. The subject video data may be from a video blog, email, a user discussion thread or other user forum based on a computer network.

### RELATED APPLICATION

This application claims the benefit of U.S. Provisional Application No. 60/660,218, filed Mar. 10, 2005, the entire teachings of which are incorporated herein by reference.

### BACKGROUND OF THE INVENTION

Early stages of the video production process include obtaining interview footage and generating a first draft of edited video. Making a rough cut, or first draft, is a necessary phase in productions that include interview material. It is usually constructed without additional graphics or video imagery and used solely for its ability to create and coherently tell a story. It is one of the most critical steps in the entire production process and also one of the most difficult. It is common for a video producer to manage 25, 50, 100 or as many as 200 hours of source tape to complete a rough cut for a one hour program.

Current methods for developing a rough cut are fragmented and inefficient. Some producers work with transcripts of interviews, word process a script, and then perform a video edit. Others simply move their source footage directly into their editing systems where they view the entire interview in real time, choose their set of possible interview segments, then edit down to a rough cut.

Once a rough cut is completed, it is typically distributed to executive producers or corporate clients for review. Revisions requested at this time involve more video editing and more text editing. These revision cycles are very costly, time consuming and sometimes threaten project viability.

### SUMMARY OF THE INVENTION

The present invention addresses the problems of the prior art by providing a computer automated method and apparatus of video editing. In a preferred embodiment, the present invention provides a video editing service over a global network, e.g., the Internet. Thus in some embodiments the present invention provides a review portal which is browser based and enables video editing via a web browser interface. In other embodiments, the present invention provides video editing in a local area network, on a stand alone configuration and in other computer architecture configurations.

In a network of computers formed of a host computer and a plurality of user computers coupled for communication with the host computer, video editing method and apparatus in one embodiment includes:
(i) a source of subject video data for the host computer, the video data including corresponding audio data;
(ii) a transcription module coupled to receive from the host computer the subject video data; and
(iii) an assembly member.

The transcription module generates a working transcript of the corresponding audio data of the subject video data and associates portions of the transcript to respective corresponding portions of the subject video data. In particular, each portion of the working transcript incorporates timing data of the corresponding portion of the subject video data. The host computer provides display of the working transcript to a user (for example, through the network) and effectively enables user selection of portions of the subject video data through the displayed transcript. The assembly member responds to user selection of transcript portions of the displayed transcript and obtains the respective corresponding video data portions. For each user selected transcript portion, the assembly member, in real time, (a) obtains the respective corresponding video data portion, (b) combines the obtained video data portions to form a resulting video work, and (c) displays a text script of the resulting video work.

The host computer provides or otherwise enables display of the resulting video work to the user upon user command during user interaction with the displayed working transcript.

The subject video data may be encoded and uploaded or otherwise transmitted to the host.

In accordance with one aspect of the present invention, the original or initial working transcript may be simultaneously (e.g., side by side) displayed with the resulting text script and/or with display of the resulting video work.

In accordance with another aspect of the present invention, the displayed working transcript is formed of a series of passages. User selection of a transcript portion includes user reordering at least some (e.g., one) of the passages in the series. In some embodiments, each passage has at least a beginning time stamp or end time stamp of the corresponding portion of subject video data. For example, the source media elapsed time defines each time stamp. In preferred embodiments, the association of portions of the working transcript to portions of the subject video data includes the use of time codes.

Further, each passage includes one or more statements. User selection of a transcript portion includes user selection of a subset of the statements in a passage. Thus, the present invention enables a user to redefine (split or otherwise divide) passages.

In a stand alone configuration or LAN embodiment, the transcription module is executed inside or outside of the network or remotely from a host computer. The formed working transcript is communicated to the host computer. User interaction is then through (i.e., on) the host computer. The transcription module may otherwise be integrated into the stand alone or LAN configuration.

Other features include incorporation of graphics, background audio (music, nature sounds, etc.) and secondary (or Role B) video with narration overlaid. The narration is from the interview footage which is transcribed and used for producing the first draft according to the principles of the invention summarized above and further detailed below.

In accordance with other embodiments, the present invention enables improved user interaction with video blogs, discussion forums (i.e., discussion threads enhanced with video), email and the like on the Internet.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic illustration of a computer network environment in which embodiments of the present invention may be practiced.

FIG. 2 is a block diagram of a computer from one of the nodes of the network of FIG. 1.

FIG. 3 is a flow diagram of embodiments of the present invention.

FIGS. 4a and 4b are schematic views of data structures supporting one of the embodiments of FIG. 3.

FIG. 5 is a schematic diagram of a web application embodiment of the present invention.

FIGS. 6a and 6b are schematic diagrams of a global computer network discussion forum application of the present invention.

### DETAILED DESCRIPTION OF THE INVENTION

A description of preferred embodiments of the invention follows.

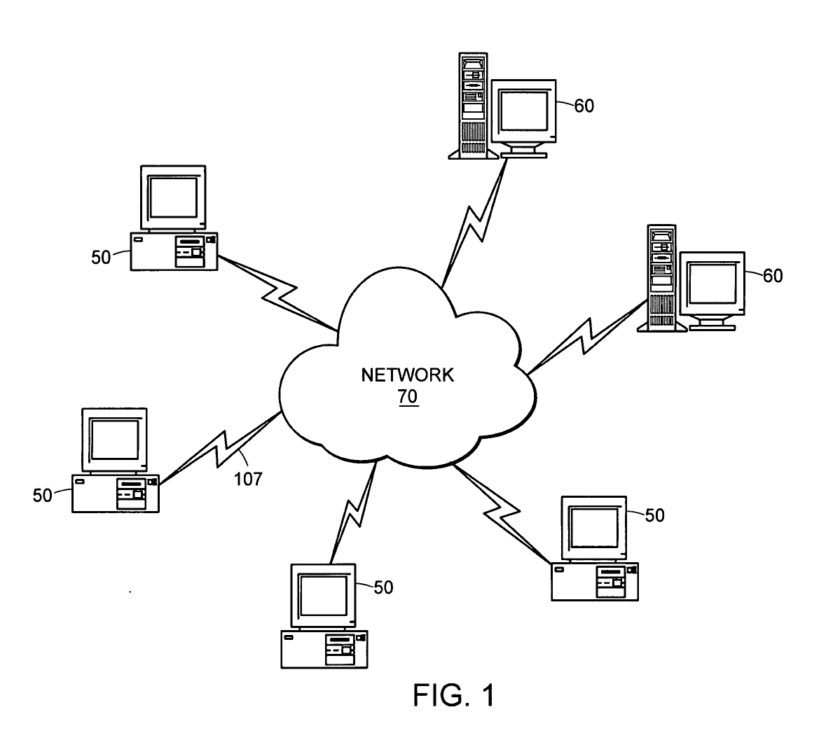

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

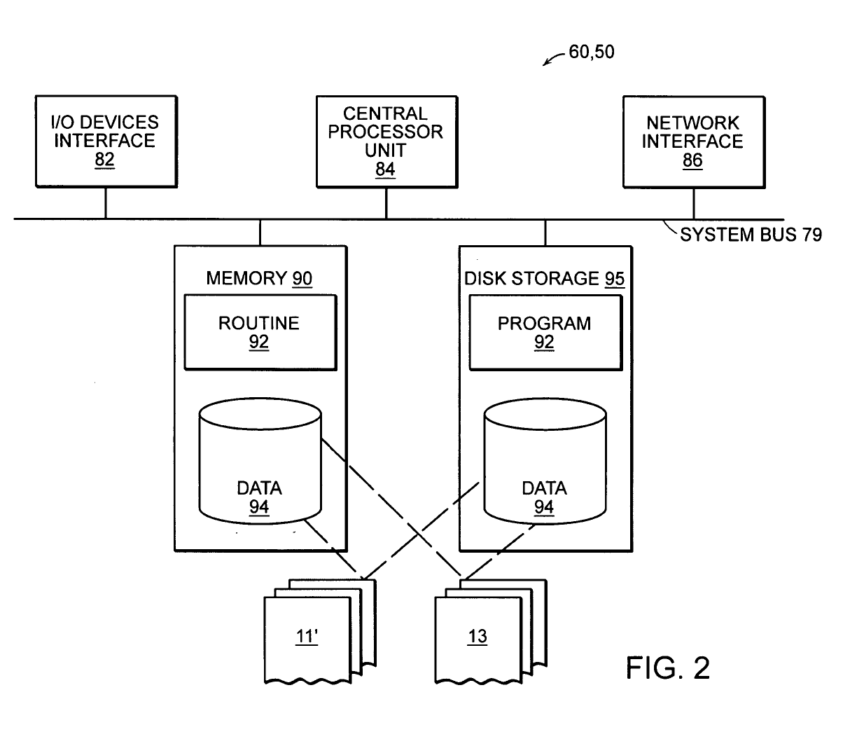

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions used to implement an embodiment of the present invention (e.g., Program Routines 92 and Data 94, detailed later). Disk storage 95 provides non-volatile storage for computer software instructions 92 and data 94 used to implement an embodiment of the present invention. Central processor unit 84 is also attached to system bus 79 and provides for the execution of computer instructions.

As will be made clear later, data 94 includes source video data files 11 and corresponding working transcript files 13. Working transcript files 13 are text transcriptions of the audio tracks of the respective video data 11. Source video data 11 may be media which includes audio and visual data, media which includes audio data without additional video data, media which includes audio data and combinations of graphics, animation and the like, etc.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92. In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

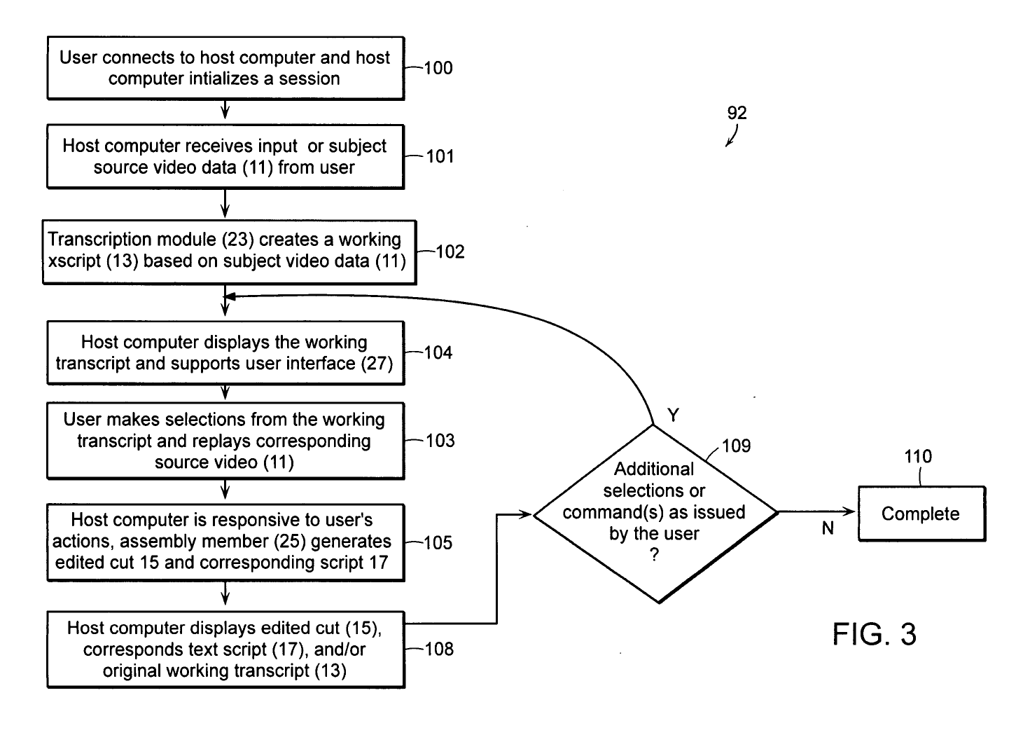

In one embodiment, a host server computer 60 provides a portal (services and means) for video editing and routine 92 implements the invention video editing system. Users (client computers 50) access the invention video editing portal through a global computer network 70, such as the Internet. Program 92 is preferably executed by the host 60 and is a user interactive routine that enables users (through client computers 50) to edit their desired video data. FIG. 3 illustrates one such program 92 for video editing services and means in a global computer network 70 environment. In other embodiments, network 70 is a local area or similar network. To that end host 60 is a server of sorts and users interact through the client computers 50 or directly on host/server 60.

At an initial step 100, the user via a user computer 50 connects to invention portal or host computer 60. Upon connection, host computer 60 initializes a session, verifies identity of the user and the like.

Next (step 101) host computer 60 receives input or subject video data 11 transmitted (uploaded or otherwise provided) upon user command. The subject video data 11 includes corresponding audio data, multimedia and the like. In response (step 102), host computer 60 employs a transcription module 23 that transcribes the corresponding audio data of the received video data 11 and produces a working transcript 13. Speech-to-text technology common in the art is employed in generating the working transcript from the received audio data. The working transcript 13 thus provides text of the audio corresponding to the subject (source) video data 11. Further the transcription module 23 generates respective associations between portions of the working transcript 13 and respective corresponding portions of the subject video data 11. The generated associations may be implemented as links, pointers, references or other loose data coupling techniques. In preferred embodiments, transcription module 23 inserts time stamps (codes) 33 for each portion of the working transcript 13 corresponding to the source media track, frame and elapsed time of the respective portion of subject video data 11.

Host computer 60 displays (step 104) the working transcript 13 to the user through user computers 50 and supports a user interface 27 thereof. In step 103, the user interface 27 enables the user to navigate through the displayed working transcript 13 and to select desired portions of the audio text (working transcript). The user interface 27 also enables the user to play-back portions of the source video data 11 as selected through (and viewed along side with) the corresponding portions of the working transcript 13. This provides audio-visual sampling and simultaneous transcript 13 viewing that assists the user in determining what portions of the original video data 11 to cut or use. Host computer 60 is responsive (step 105) to each user selection and command and obtains the corresponding portions of subject video data 11. That is, from a user selected portion of the displayed working transcript 13, host computer assembly member 25 utilizes the prior generated associations 33 (from step 102) and determines the portion of original video data 11 that corresponds to the user selected audio text (working transcript 13 portion).

The user also indicates order or sequence of the selected transcript portions in step 105 and hence orders corresponding portions of subject video data 11. The assembly member 25 orders and appends or otherwise combines all such determined portions of subject video data 11 corresponding to user selected portions and ordering of the displayed working transcript 13. An edited version 15 of the subject video data and corresponding text script 17 thereof results.

Host computer 60 displays (plays back) the resulting video work (edited version) 15 and corresponding text script 17 to the user (step 108) through user computers 50. Preferably, host computer 60, under user command, simultaneously displays the original working transcript 13 with the resulting video work/edited (cut) version 15. In this way, the user can view the original audio text and determine if further editing (i.e., other or different portions of the subject video data 11 or a different ordering of portions) is desired. If so, steps 103, 104, 105 and 108 as described above are repeated (step 109). Otherwise, the process is completed at step 110.

Thus the present invention provides an audio-video transcript based video editing process using on-line display of a working transcript 13 of the audio corresponding to subject source video data 11. Further, the assembly member 25 generates the edited/cut version 15 (and corresponding text script 17) in real time of the user selecting and ordering (sequencing) corresponding working transcript portions. Such a real-time, transcript based approach to video editing is not in the prior art.

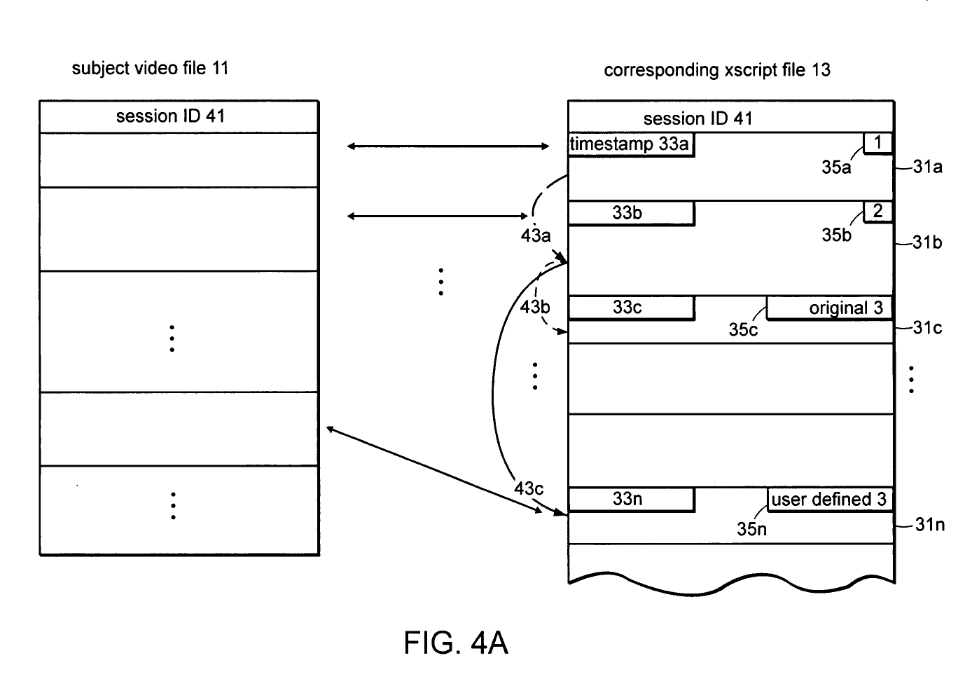

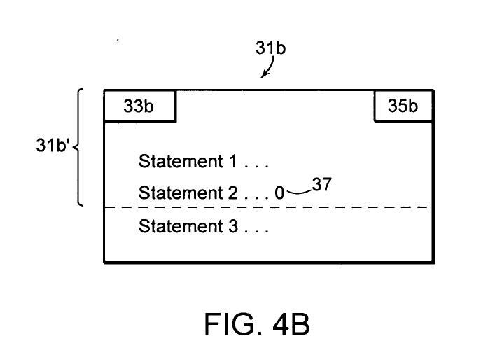

Further, in order to handle multiple of such users and multiple different source video data 11, the host computer 60 employs data structures as illustrated in FIGS. 4a and 4b. A source video data file 11 is indexed or otherwise referenced with a session identifier 41. The session identifier is a unique character string, for example. The corresponding transcript file 13 is also tagged/referenced with the same session identifier 41. The transcript file 13 holds associations (e.g., references, pointers or links, etc.) 33 from different portions of the working transcript to the respective corresponding portions of source video data 11 (as illustrated by the double headed arrows in the middle of FIG. 4a). Preferably a working transcript 13 is formed of a series of passages 31a, b, . . . n. Each passage 31 includes one or more statements of the corresponding videoed interview (footage). Each passage 31 is time stamp indexed (or otherwise time coded) 33 by track, frame and/or elapsed time of the original media capture of the interview (footage). Known time stamp technology may be utilized for this associating/cross referencing between passages 31 of transcript files 13 and corresponding source video files 11.

Also, each passage 31 has a user definable sequence order (1, 2, 3 . . . meaning first, second, third . . . in the series of passages). The passages 31 that are not selected for use by the user (during steps 104, 105, FIG. 3, for example) are not assigned a respective working sequence order. The ordering or sequencing of the user selected passages 31 is implemented by sequence indicators 35 and a linked list 43 (or other known ordering/sequencing techniques). In response to user setting or changing sequence order indicators 35 of user selected passages 31, assembly member 25 updates the supporting linked list 43.

In the example illustrated in FIG. 4a, the initial order of the passages from source video data 11 was passage 31a followed by passage 31b, followed by passage 31c and so on as the values in indicators 35a, b, c show. The initial linked list thus was formed of link 43a to link 43b and so forth (shown in dashed lines). During user interaction (steps 103, 104, 105 of FIG. 3), the user decides to select passages 31a, 31b and 31n in that order, omitting passage 31c. Indicators 35a, b and n show the user selected new order (working series of passages 31a, b and n). Assembly member 25 adjusts the linked list 43a, 43c accordingly so that user selected first in series passage 31a is followed by user selected second in series passage 31b (link 43a), and user selected third in series passage 31n immediately follows passage 31b (link 43c). Initial link 43b and initial third in series passage 31c are effectively omitted. Then upon user command to play back this edited version 15, assembly member 25 (i) follows link list 43a, 43c which indicates passage 31a is to be followed by passage 31b followed by passage 31n, (ii) obtains through respective time stamps 33a, b, the corresponding source video data 11 for these passages, and (iii) combines (appends) the obtained source video data in that order (as defined by the user through indicators 35).

In addition, the user may select only part of a desired passage 31 instead of the whole passage. During steps 103, 104, 105, the user replays video data 11 corresponding to a passage 31 of interest and follows along reading the text of the passage 31 through the displayed working transcript 13. Between what the user sees in the video and reads in the corresponding transcript passage 31, he can determine what portion (parts or statements) of the subject passage 31 and corresponding video he desires. As illustrated in FIG. 4b, the user interface 27 allows the user to define the desired subparts by indicating one or more stop points 37 in the subject passage 31b during replay of the corresponding video data 11. In the illustrated example, the first two of three statements are effectively selected by the user where the stop point 37 is placed between the end of Statement 2 and before Statement 3. Other placements to select other combinations of statements (in whole or part) are effected similarly. The present invention system determines corresponding time stamps (track/frame/elapse time of original video medium) for the user specified stop points 37. This effectively forms from subject passage 31b an adjusted or user defined working passage 31b′. Use of the adjusted/redefined passage 31b′ in the series of user selected and ordered passages 31 for generating edited cut 15 are then as described above in FIG. 4a.

Alternatively, the present invention may be implemented in a client server architecture in a local area or wide area network or effectively on a stand alone computer configuration instead of the global network 70. In the local area network or stand alone configuration, the host computer 60 provides display of the working transcript 13, edited/cut version 15, corresponding text script 17, etc., to the user and receives user interaction in operating the present invention. The transcription operation/module 23 is executed on a computer outside of the network (separate and remote from the stand alone/host computer 60), and the formed working transcript 13 is electronically communicated to host computer 60 (for example by email) for use in the present invention. The host computer 60 utilizes file maker or similar techniques for enabling upload of working transcript 13 into data store 94 and working memory of host 60. Thus a transcription service may be employed as transcription module 23. In other embodiments, transcription module 23 is an integrated component of host computer 60.

Other configurations are within the purview of one skilled in the art given this disclosure of the present invention.

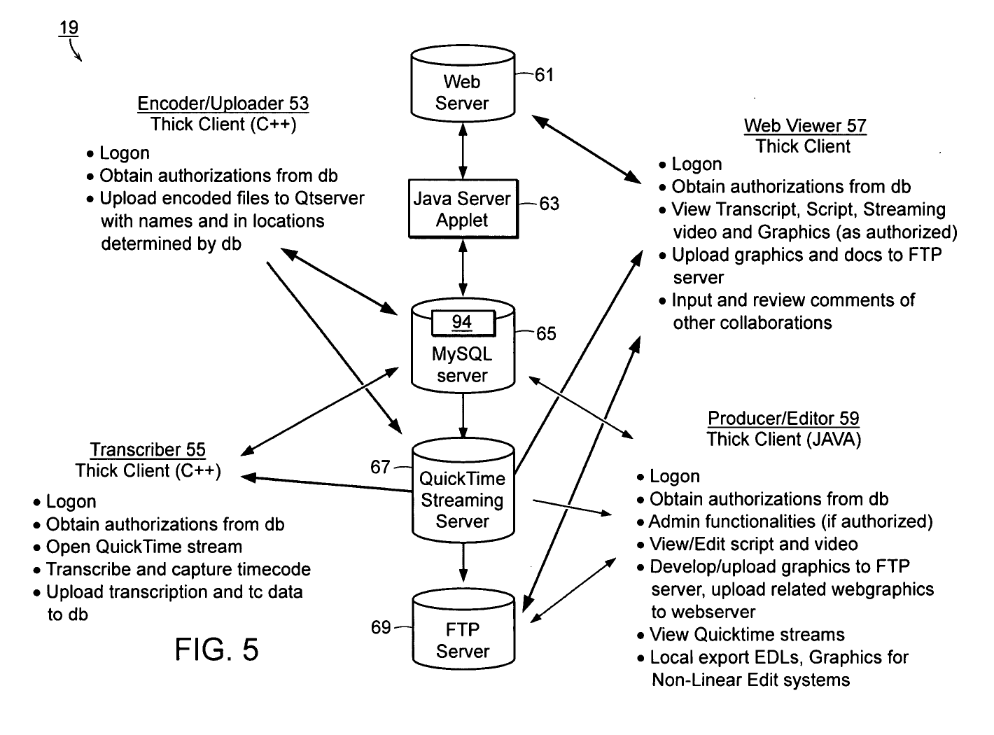

Turning now to FIG. 5, in another embodiment of the present invention 19, routine/program 92 provides a web application. In that embodiment, server 60 includes a web server 61, a Java applet server 63, an SQL or other database management server 65, a streaming data (e.g., Quick Time) server 67, and an FTP server 69. Clients 50 include an encoder/uploader 53, a transcriber 55, a web viewer 57 and a producer/editor 59. In some embodiments, at least the web viewer 57 and producer/editor 29 are browser based.

The encoder/uploader client 53 enables a user to digitize interview footage from the field into a file 11 for the invention database/datastore (generally 94). The user (through client 53) calls and logs on to the SQL server 65. Client 53 enables the user to encode the subject source video file 11 and to register it with the SQL server 65. In response, SQL server 65 determines file name and file tree location on the streaming server 67 to which the user is to upload the subject video file 11. Client 53 accordingly transmits the subject video file 11 to streaming server 67 using the file name and location determined by SQL server 65.

The transcriber client 55 enables a user responsible for transcribing video files 11 (audio portion thereof) to interface with the invention system 19. Through transcriber client 55, a user logs on to SQL server 65 and obtains authorization/access privileges to video files 11 (certain ones, etc.). The user requests a subject video file 11 for transcribing and in response SQL server 65 initiates (or otherwise opens) a data stream from Quick Time (streaming) server 67 to client 55. In turn, transcriber client 55 enables the user to (i) transcribe the subject video 11 (corresponding audio) into text, and to (ii) capture time codes 33 from original source media that was uploaded to streaming server 67 from uploader/encoder client 53. Upon completion of the transcription and time coding, the user/client 55 uploads the resulting transcript 13 to the datastore 94 (SQL server 65).

In some embodiments, transcriber client 55 is a transcription service.

The producer/editor client 59 enables a user to log on to SQL server 65 and gain authorized access to his video editing projects. The producer/editor client 59 enables a user to read and navigate through a working transcript 13 making selections, partitions (of passages 31) and ordering as described in FIGS. 4a and 4b. Thus, producer/editor client 59 enables its user to generate and view edited cuts 15 and corresponding text script 17 in accordance with the principles of the present invention (i.e., through the corresponding working transcript 13 and in real time of user command to move all selected passages 31 to a resulting text script 17 and view the corresponding edited video cut 15). The streaming server 67 supplies to client 59 the streaming video data 11 of each user selected passage 31 in user defined order. SQL server 65 manages operation of streaming server 67 including determining database location of pertinent video data supporting the display of the edited cut 15.

Further, client 59 employs a platform that directs file management and control of applications to stay within context of the project. For example, in one embodiment producer/editor client 59 automatically opens a photo or image viewing application such as “Photoshop”. This enables the user to crop or otherwise edit the images for the edited cut 15. Audio applications and animation applications are similarly controlled with respect to the edited cut 15. Further, client 59 enables the user to develop and upload graphics and related web graphics to respective servers 69, 61 without the need (of the user) to specify a file name or location. Instead, SQL server 65 manages the checking in and out of files per project using known or common in the art techniques. As the user of client 59 utilizes each of these and other secondary applications, file names, contents and work flow are interpreted (defined and applied) within context of the given project.

In another feature of the preferred embodiment, background audio/video, such as music or nature sounds, nature scenes, etc., may be added to the working edited cut 15 using the Power Point style of screen views and user defined associations therein. In the case of background audio, the working transcript 13 is the text transcription of, for example, a narration and the background audio is the corresponding audio of a video visual (or background video). An example is a production piece on a music school. Video clips of musicians playing (i.e., the audio including piano music and the video showing the pianist at work) are taken in the field. An interview off or on location at the music school is also captured (at least as audio source data) and provides narration describing the music school. The interview/narration is used as the main audio of the subject production and the text of the narration is transcribed in the working transcript 13. Through the client 59, the user is able to view the transcript 13 of the interview and edit the flow of the narration accordingly while having the background audio and video replay the musician scene. Thus, the narration is overlaid on the background audio and video (video clips of musicians playing) and provides the subject edited video cut 15.

The web viewer client 57 enables a user, such as a customer for whom the edited cut 15 has been made, to log onto web server 61 and obtain authorized access to his projects. After authentication by web server 61, the user of web viewer client 57 is able to select and view a draft or edited cut 15 of his projects. During such viewing, web viewer client 57 displays corresponding working transcript 13, the resulting script 17 corresponding to the edited/draft cut 15 and associated graphics. The original source video data 11 is also viewable upon user command. The SQL server 65 manages the streaming server 67 to provide streaming video data to web viewer client 57 to support display of the edited/draft cut 15 and/or original source video data 11. In addition, web viewer client 57 enables its user to upload graphics and documents to the FTP server 69. In a preferred embodiment, web viewer client 57 provides a user interface allowing the user to input his comments and to review comments of other collaborators of the subject project. Communications between web server 61 and SQL server 65 are supported by Java server applets 63 or similar techniques known in the art.

In other embodiments, the present invention may be applied to video blogs, email, discussion threads enhanced with video and similar forums in a global computer network (e.g., the Internet). For example, the encoder/uploader 53 is local (situated at the local computer 50 and connected via the Internet) or remote (situated within the system of hosting computers 50, 60).

The transcriber client 55 is local, or situated remotely within the system of hosting computers. Preferably transcriber client 55 is in combination with a voice recognition module and text to video mapping as disclosed in U.S. Provisional Application No. 60/714,950 (by assignee) and herein incorporated by reference.

The producer/editor client 59 is based in a web browser. The “producer/editor” client is a “web editor” client.

The web viewer client 57 is also based in the web browser and is essentially the “viewing” component of the “producer/editor” client 59. Together the web viewer 57 and producer/editor client 59 may be referred to as the “web editor/viewer” client 57, 59.

In this embodiment, the host computer 60 opens a portal which includes access to the above components (encoder/uploader 53, transcriber client 55, web editor/viewer 57, 59).

The portal receives transmitted digitized audio and video media 11. In addition to the media sources previously specified, a webcam connected to the local computer 50 supplies a signal to either (1) a locally situated, encoder/uploader applet for sending the encoded media files to hosting computers 60, or (2) a remote server based encoding component that creates the media file and stores the file on the hosting computer 60.

Next the transcriber client 55 receives access to the hosted media file and generates a working transcript 13 corresponding to the media file, linked by the timecodes of the source media file as previously described in other embodiments.

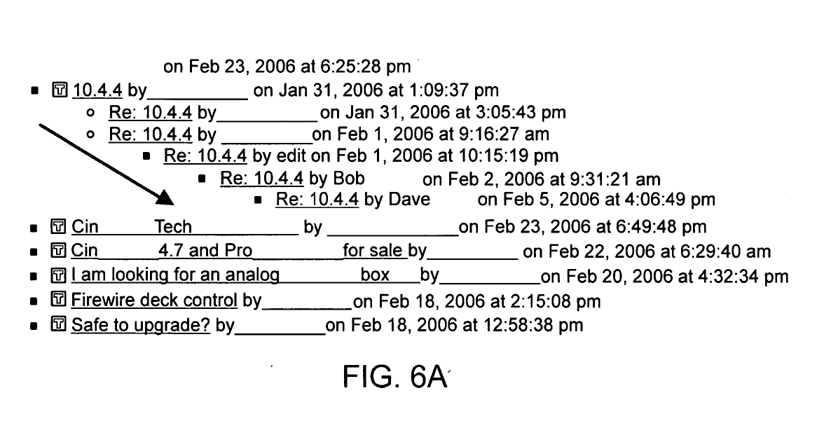

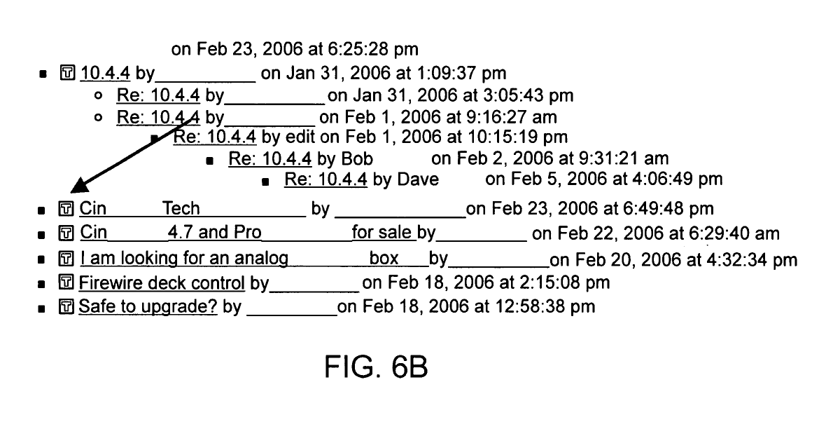

The web editor/viewer 57, 59 displays video segments and corresponding passages 31 of working transcripts 13 as described in FIGS. 3-5. In addition, segment data derived from the media files and their corresponding working transcript 13 portions are organized analogous to the client, project, topic, etc., arrangement in FIG. 5 but indicated as level 1, level 1.1, level 1.1.1 in this embodiment. FIGS. 6a-6b are illustrative.

Web-based user interface components sort and ultimately display segment data including audio and video streaming media and corresponding text script 17.

Segment data for the media file displayed within the portal is user (viewer) edited, placed in a sequence together with other segment data described previously in other embodiments and accessed in real-time playback mode. This sequence, in a web-centric implementation is analogous to a “thread”, where the real-time playback is directed to follow along structure similar to that shown in FIGS. 6a-6b and is directed by the user in real-time to pursue tangents of the thread, or return to the main thread. FIG. 6a illustrates playback of a user directed tangent thread, while FIG. 6b illustrates playback or return to the main thread.

While this invention has been particularly shown and described with references to preferred embodiments thereof, it will be understood by those skilled in the art that various changes in form and details may be made therein without departing from the scope of the invention encompassed by the appended claims.

What is claimed is:

1. In a network of computers formed of a host computer and a plurality of user computers coupled for communication with the host computer, video editing apparatus comprising:
a source of subject video data for the host computer, the video data including corresponding audio data;
a transcription module coupled to receive from the host computer the subject video data, the transcription module generating a working transcript of the corresponding audio data of the subject video data and associating portions of the working transcript to respective corresponding portions of the subject video data, the host computer providing display of the working transcript to a user and enabling effective user selection of portions of the subject video data through the displayed working transcript; and
an assembly member responsive to user selection of a transcript portion of the displayed working transcript and obtaining the respective corresponding video data portion, for each user selected transcript portion, the assembly member, in real-time, (i) obtaining the respective corresponding video data portion and (ii) combining the obtained video data portions to form a resulting video work, the resulting video work having a corresponding text script,
the host computer providing real-time display of the resulting video work to the user upon user command during user interaction with the displayed working transcript.

2. Apparatus as claimed in claim 1 wherein the host computer displays the resulting video work simultaneously with any combination of display of the working transcript and display of the text script of the resulting video work.

3. Apparatus as claimed in claim 1 wherein the network of computers is a global network.

4. Apparatus as claimed in claim 1 wherein the host computer enables display of the resulting video work to other users.

5. Apparatus as claimed in claim 1 wherein the displayed working transcript is formed of a series of passages, and
user selection of a transcript portion includes user reordering at least some of the passages in the series.

6. Apparatus as claimed in claim 5 wherein each passage includes one or more statements, and user selection of a transcript portion includes user selection of a subset of the statements in a passage.

7. Apparatus as claimed in claim 5 wherein each passage has at least one of a beginning time code and an end time code of the corresponding portion of subject video data.

8. Apparatus as claimed in claim 1 wherein the host computer enabling effective user selection of portions of the subject video data through the displayed working transcript includes enabling user ordering of user selected portions.

9. Apparatus as claimed in claim 1 wherein the network of computers is a local area network.

10. Apparatus as claimed in claim 9 wherein the transcription module is executed on a computer outside of the local area network but in communication with the host computer, and
display of the working transcript and user interaction with the displayed working transcript is through the host computer.

11. Apparatus as claimed in claim 1 wherein the source of subject video data is any of a video blog, email, a user discussion thread enhanced with video and a user forum based on a computer network.

12. In a network of computers formed of a host computer and a plurality of user computers coupled for communication with the host computer, a method of editing video comprising the steps of:
receiving a subject video data at the host computer, the video data including corresponding audio data;
transcribing the received subject video data to form a working transcript of the corresponding audio data;
associating portions of the working transcript to respective corresponding portions of the subject video data;
displaying the working transcript to a user and enabling user selection of portions of the subject video data through the displayed working transcript, said user selection including sequencing of portions of the subject video data;
for each user selected transcript portion from the displayed working transcript, in real-time, (i) obtaining the respective corresponding video data portion and (ii) combining the obtained video data portions to form a resulting video work, the resulting video work having a corresponding text script; and
providing display of the resulting video work to the user upon user command during user interaction with the displayed working transcript.

13. A method as claimed in claim 12 wherein the step of providing display includes simultaneously displaying to the user any combination of the resulting video work, the corresponding text script and the working transcript.

14. A method as claimed in claim 12 wherein the network of computers is a global network.

15. A method as claimed in claim 12 further comprising the step of enabling display of the resulting video work to other users.

16. A method as claimed in claim 12 wherein the displayed working transcript is formed of a series of passages, and
user selection of a transcript portion includes user reordering at least some of the passages in the series.

17. A method as claimed in claim 16 wherein each passage includes one or more statements, and user selection of a transcript portion includes user selection of a subset of the statements in a passage.

18. A method as claimed in claim 16 further comprising the step of providing each passage with at least one of a beginning time code and an end time code of the corresponding portion of subject video data.

19. A method as claimed in claim 12 further comprising the step of incorporating any combination of graphics, images, animation and additional audio into the resulting video work.

20. A method as claimed in claim 12 wherein the step of transcribing includes connecting a transcriber user to the host to obtain one or more transcription jobs, the transcriber user (i) accessing subject video data with host permission and (ii) generating the working transcript.

21. A method as claimed in claim 12 wherein the network of computers is a local area network.

22. A method as claimed in claim 21 wherein the step of transcribing is performed outside of the local area network and the working transcript is electronically communicated to the host computer.

23. A method as claimed in claim 12 wherein the step of receiving subject video data includes video data from any of a video blog, email, a user discussion thread enhanced with video and a user forum based on a computer network.

24. A computer system for video editing comprising:
means for receiving subject video data, the subject video data including corresponding audio data;
means for transcribing the corresponding audio data of the subject video data, the transcribing means generating a working transcript of the corresponding audio data and associating portions of the working transcript to respective corresponding portions of the subject video data; and
means for displaying the working transcript to a user and enabling user selection of portions of the subject video data through the displayed working transcript, the display and user selection means including for each user selected transcript portion from the displayed working transcript, in real-time, (i) obtaining the respective corresponding video data portion, (ii) combining the obtained video data portions to form a resulting video work and (iii) displaying the resulting video work to the user upon user command during user interaction with the displayed working transcript.

25. A computer system as claimed in claim 24 wherein the displayed working transcript is formed of a series of passages, each passage includes one or more statements, and
user selection of a transcript portion includes user reordering at least some of the passages in the series and/or user selection of a subset of the statements in a passage.

26. A computer system as claimed in claim 24 wherein the resulting video work includes a corresponding text script.

27. A computer system as claimed in claim 24 wherein the means for transcribing is remote from the means for displaying.

28. A computer system as claimed in claim 24 wherein the subject video data includes video data from any of a video blog, email, a user discussion thread and a user forum based on a computer network.

29. A computer method of editing video comprising the steps of:
receiving a subject video data at a user computer, the video data including corresponding audio data;
transcribing the received subject video data to form a working transcript of the corresponding audio data;
at the user computer, associating portions of the working transcript to respective corresponding portions of the subject video data;
displaying the working transcript to a user and enabling user selection of portions of the subject video data through the displayed working transcript, said user selection including sequencing of portions of the subject video data;
for each user selected transcript portion from the displayed working transcript, in real-time, (i) obtaining the respective corresponding video data portion and (ii) combining the obtained video data portions to form a resulting video work, the resulting video work having a corresponding text script; and
providing display of the resulting video work to the user upon user command during user interaction with the displayed working transcript.
